(19) United States
(12) Patent Application Publication
(10) Pub. No.: US 2011/0255133 A1
(43) Pub. Date: Oct. 20, 2011

(54) EXTERNAL STORAGE FOR IMAGING DEVICES

(76) Inventors: Pablo Dominguez Pastor, Barcelona (ES); Luis Alberto Hernando Sanz, Sant Cugat del Valles (ES); Angel Martinez Barambio, Barcelona (ES)

(21) Appl. No.: 12/761,743

(22) Filed: Apr. 16, 2010

(51) Int. Cl. G06K 15/00

(52) U.S. Cl. 358/1.16

(57) ABSTRACT

Imaging devices and external storage media facilitate secured storage of user-specific data. An imaging device includes a processor configured to detect coupling of an external storage medium to the imaging device, to perform an authentication process upon detecting the coupling of an external storage medium, and to disable storage of print job data to an internal storage medium of the imaging device in response to authenticating an external storage medium. The imaging device processor may further be configured to determine if the internal storage contains identification information, and to perform the authentication process if the internal storage medium does not contain identification information.

### BACKGROUND

Tangible output may be generated by devices broadly known as imaging devices. Imaging devices include laser printers, inkjet printers, copiers, facsimile machines, plotters, multi-function devices and other devices used for applying an image to a tangible print media, such as paper, transparencies, card stock and more. The image is applied to the print media using a marking material, e.g., ink, ribbon, toner, or other means of applying an image to the print media.

Imaging devices often include a storage medium, such as an internal hard drive or other non-volatile memory. This storage medium is used for storing instructions used by the imaging device for its operation, e.g., software instructions for causing the imaging device to perform the various tasks associated with converting image data to some tangible output, values of user-selectable settings and other device-specific information. This storage medium may also be used to store information specific to one or more users of the imaging device. For example, the storage medium may be used to store document or graphic files that a user of the imaging device may access to produce tangible output directly from the imaging device without generating another print job. As a further example, the storage medium may further contain temporal files used in the creation of tangible output in response to some print job containing image data. In security-conscious environments, this non-volatile storage of user-specific information may be problematic if the imaging device is unattended.

For the reasons stated above, and for other reasons that will become apparent to those skilled in the art upon reading and understanding the present specification, there is a need in the art for alternative methods and apparatus for securing imaging device storage.

### BRIEF DESCRIPTION OF THE DRAWINGS

FIG. 1 is a block schematic of an imaging device coupled to an external storage medium in accordance with an embodiment of the disclosure.

FIG. 2 is a flowchart of a method of operating an imaging device in accordance with an embodiment of the disclosure.

FIGS. 3, 3A and 3B are flowcharts of a method of operating an imaging device in accordance with another embodiment of the disclosure.

FIG. 4 is a block schematic of a storage medium in accordance with an embodiment of the disclosure.

### DETAILED DESCRIPTION

In the following detailed description of the present embodiments, reference is made to the accompanying drawings that form a part hereof, and in which is shown by way of illustration specific embodiments of the disclosure which may be practiced. These embodiments are described in sufficient detail to enable those skilled in the art to practice the subject matter of the disclosure, and it is to be understood that other embodiments may be utilized and that process, mechanical or electrical changes may be made without departing from the scope of the present disclosure. The following detailed description is, therefore, not to be taken in a limiting sense.

Various embodiments include imaging devices and methods of their operation in conjunction with external storage media. Various embodiments further include storage media for use with such imaging devices to form an imaging system. The imaging devices are configured to detect the coupling of an external storage medium, to perform an authentication process for the external storage medium, and to disable storage of print job data to an internal storage medium of the imaging device if the external storage medium is authenticated. Other embodiments include apparatus and methods of varying scope.

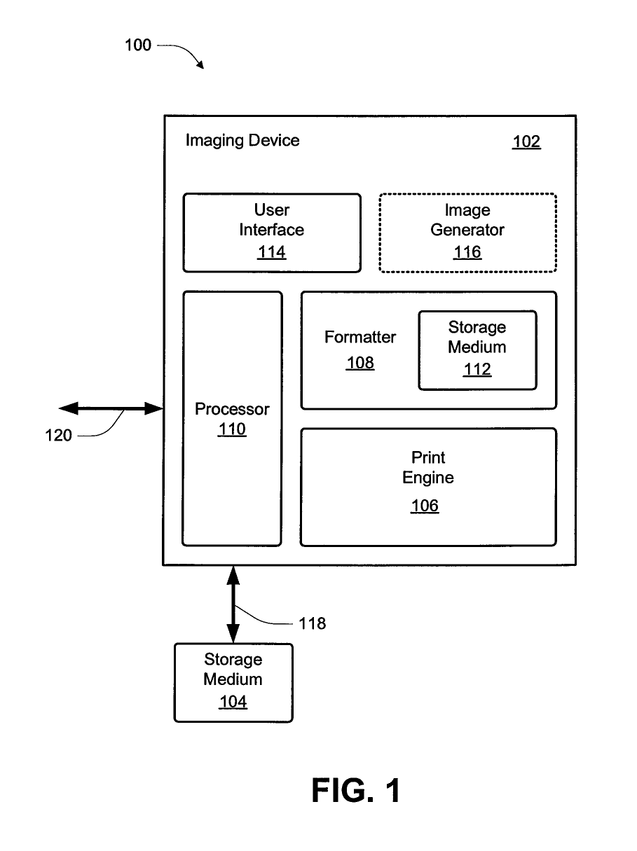

FIG. 1 is a schematic block schematic of an imaging device 102 coupled to a storage medium 104 external to the imaging device 102 in accordance with an embodiment of the disclosure. The imaging device 102 and storage medium 104 external collectively form an imaging system 100.

The external storage medium 104 is coupled to the imaging device 102 through a peripheral port 118. The peripheral port 118 is some form of I/O (input/output) port for connecting to a peripheral device, such as an external hard drive, solid-state drive, thumb drive, or the like. Some examples of peripheral port 118 include a Universal Serial Bus (USB) connection, an IEEE 1394a High Speed Serial Bus connection, an IR (infrared) I/O port and other wired and wireless I/O ports.

The imaging device 102 accepts print job and other data on a communication port 120. The communication port 120 is some form of I/O port for communicating with an external host device (not shown), e.g., a computer workstation or other processor-based device. Some examples of communication port 120 include a parallel I/O port, a serial I/O port, a Gigabit Ethernet (1000 Base-T) port, a USB connection, an IEEE 1394a High Speed Serial Bus connection, an IR I/O port and other wired and wireless I/O ports.

A formatter 108 of the imaging device 102 receives the print job data. Print job data includes image data and control data used by the imaging device 102 to produce a tangible output representative of the image data. Print job data may sometimes be referred to as a page description. A variety of high-level page description languages (PDLs) provide information to an imaging device on how to recreate a desired image. These PDLs are often device-independent languages, i.e., the same image data can be provided to devices of differing types and/or differing manufacturers to produce an end result that is substantially the same. Examples of PDLs include Printer Command Language or PCL-XL (Hewlett-Packard Company, Palo Alto, Calif., USA), PostScript® (Adobe Systems Incorporated, San Jose, Calif., USA) and Interpress (Xerox Corporation, Stamford, Conn., USA). In addition to containing data representative of the desired output image, page descriptions also generally contain other information related to the control of the imaging device, e.g., what media tray to pull print media from, what resolution to use, whether the output should be in color or black and white, etc.

The formatter 108 converts or renders the print job data into a printable image. At this stage, the printable image is typically raster data. The print engine 106 takes this printable image and produces the tangible output (not shown). The print engine 106 represents the mechanical aspects of the imaging device 102 used to produce the tangible copy representative of the print job data.

The imaging device 102 further includes a processor 110. Although shown as independent to the formatter 108, the processor 110 may be integral to the formatter 108 and may control the actions of the formatter 108 and the print engine 106. The processor 110 is configured to perform methods in accordance with embodiments of the disclosure in response to computer-readable instructions. These computer-readable instructions are stored on a computer-usable storage medium, and may be in the form of software, firmware and/or hardware. In a hardware solution, the instructions are hard coded as part of a processor, e.g., an application-specific integrated circuit (ASIC) chip. In a software or firmware solution, the instructions are stored for retrieval by the processor 110. Some examples of computer-usable storage media include non-volatile solid-state memory (such as flash memory), magnetic media and optical media, whether permanent or removable. For the embodiment depicted in FIG. 1, the imaging device 102 includes a storage medium 112, which includes at least some form of non-volatile, re-writeable memory.

In addition to storing computer-readable instructions for causing processor 110 to perform methods in accordance with embodiments of the disclosure, storage medium 112 may also be used to store print job data, temporal files associated with the print job data, and other user-specific data, if such use has not been disabled in response to authenticating an external storage medium 104 as will be described later.

The imaging device 102 may further include a user interface 114 for displaying messages, menus, status and other information to a user of the imaging device 102. The user interface 114 further includes an input device (not shown) for receiving information from the user, such as menu choices, information requests, data input and the like. Some common examples include a liquid crystal display (LCD) with a keypad, a touch screen, or a monitor and keyboard. For various embodiments, the user interface 114 is in communication with the processor 110.

As an alternative, or in addition, to receiving print job data from an external host device, the imaging device 102 may include an image generator 116, e.g., an image scanner such as a copier bed or an image capture device such as a digital camera.

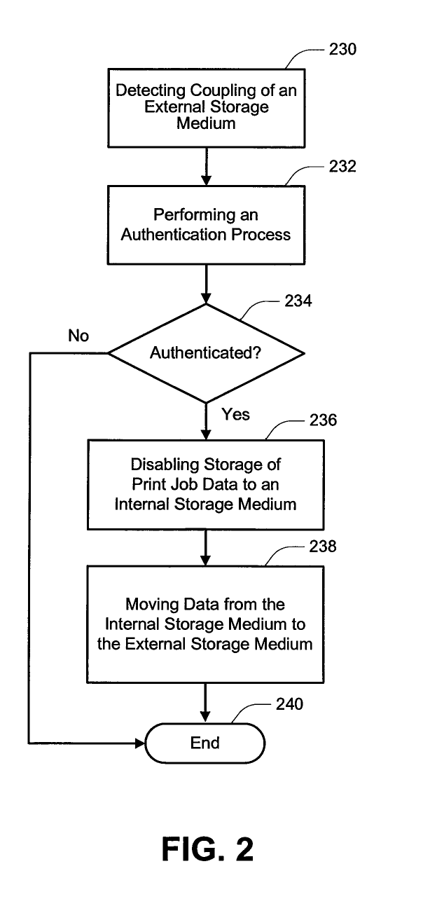

FIG. 2 is a flowchart of a method of operating an imaging device in accordance with an embodiment of the disclosure. The coupling of an external storage medium is detected at 230. For example, the imaging device processor may periodically monitor its peripheral port for the coupling of an external device. Detection is facilitated when a device configured to mate with the peripheral port is connected, and communication is established between the imaging device and the coupled external device to determine what type of device was connected. Such detection of peripheral devices, such as external hard drives, other storage media and the like, is well understood.

In response to detecting the coupling of an external storage medium, an authentication process is performed for the external storage medium at 232. The authentication process is performed by the imaging device processor to determine whether the external storage medium is suitable for use with various embodiments described herein. In general, this includes reading identification (ID) information from the external storage device, and determining whether a storage medium identified by the ID information satisfies a particular set of characteristics. The ID information may be encrypted using a technique for which the imaging device contains, or is capable of deriving, an associated key

For one embodiment, the particular set of characteristics may include that the file structure of the storage medium itself be configured for data-at-rest encryption compatible with the imaging device. For example, the storage medium may be formatted using a sector scrambling technique for which the imaging device contains, or is capable of deriving, an associated key. For another embodiment, the particular set of characteristics may include a particular capacity of the storage medium. For a further embodiment, the particular set of characteristics may include a particular type of storage medium, e.g., magnetic hard drive, optical hard drive, solid-state drive, thumb drive, etc. For a still further embodiment, the particular set of characteristics may include a particular source of the storage medium.

For certain embodiments, portions of an authenticated external storage medium may be erased in response to being authenticated. For further embodiments, a user of the imaging device may be prompted, such as through the user interface, to accept erasure of the external storage medium. If erasure is not accepted in such an embodiment, the external storage medium may be deemed to be not authenticated. This would facilitate use of an external storage medium with a specific imaging device, and erasure of information associated with use of the storage medium on one imaging device should the user try to use that storage medium on a different, similarly-configured imaging device.

If the coupled external storage medium is not authenticated at 234, i.e., is determined not to meet the particular set of characteristics or simply deemed to be not authenticated, the method may be complete at 240. If the coupled external storage medium is authenticated at 234, i.e., is determined to have at least those characteristics of the imaging device's particular set of characteristics, the processor disables storage of print job data to an internal storage medium of the imaging device at 236.

By disabling the storage of print job data to the internal storage medium, the print job data can be solely stored on the external storage medium. This facilitates the ability to secure any sensitive data associated with a print job by simply removing and securing the external storage medium. Because external storage media, e.g., USB hard disk drives or thumb drives, are typically orders of magnitude smaller than imaging devices, securing the external storage medium is a much simpler task than securing the imaging device.

In prior imaging devices, rather than attempt to secure the imaging device, users have been known to remove the imaging device's internal storage medium, such as by removing an entire formatter unit containing the internal storage medium, in order to secure user-specific data without securing the imaging device. However, imaging devices are generally not manufactured to be disassembled and reassembled on a routine basis, and this manner of securing data can lead to mechanical failure of the imaging device contacts. By disabling storage of print job data to the internal storage medium, there is no need to disassemble the imaging device to secure user-specific data.

For enhanced levels of securing data, in addition to disabling storage of print job data, the processor may further disable storage of temporal files associated with the print job data to the internal storage medium. In this regard, the processing of the print job data to produce the printable image for the print engine, for example, may utilize the external storage medium for generation of temporal files instead of the internal storage medium. Again, this facilitates the ability to secure this data by removing and securing the external storage medium. For still further enhanced levels of securing data, the processor may disable storage of all user-specific data to the internal storage medium in response to authenticating an external storage medium. In general, all data for which the processor disables storage to the internal storage medium will be stored to the external storage medium.

For further security enhancements, data currently residing on the internal storage medium may be moved to the external storage medium at 238. For example, existing print job data may be copied from the internal storage medium to the external storage medium, and then that data may be erased from the internal storage medium. For secure environments, erasure of data from the internal storage medium would generally include some form of secure erase operation, e.g., a repeated overwriting of random or other non-sensitive data (e.g., alternating between writing all 1s and writing all 0s) to all physical storage locations associated with the data to be erased.

For some embodiments, all user-specific data is moved from the internal storage medium to the external storage medium upon being authenticated. For other embodiments, only that data for which storage to the internal storage medium is disabled will be moved to the external storage medium. The data that is moved from the internal storage medium to the external storage medium may only be a portion of the data contained on the internal storage medium. For example, while user-specific data may be moved, device-specific data may remain. Because there is generally no need to secure device-specific data, leaving this data on the internal storage device permits the use of an external storage device of smaller capacity, and facilitates an increased speed in the process of moving data as copying and erasing times are generally proportional to the amount of data being copied and erased, respectively. Note that the imaging device may be unavailable during the process of moving data from the internal storage medium to the external storage medium.

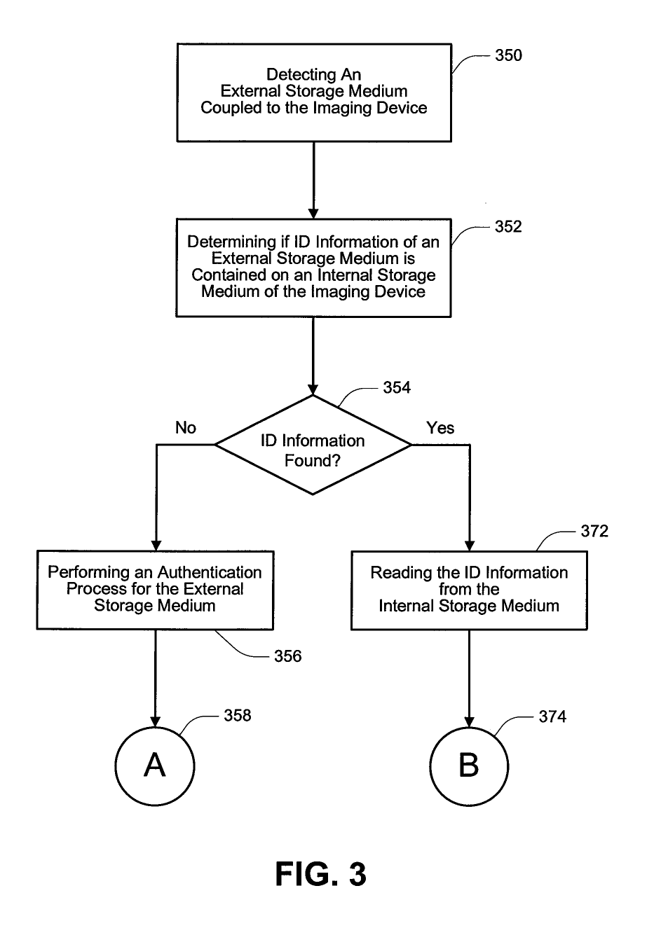

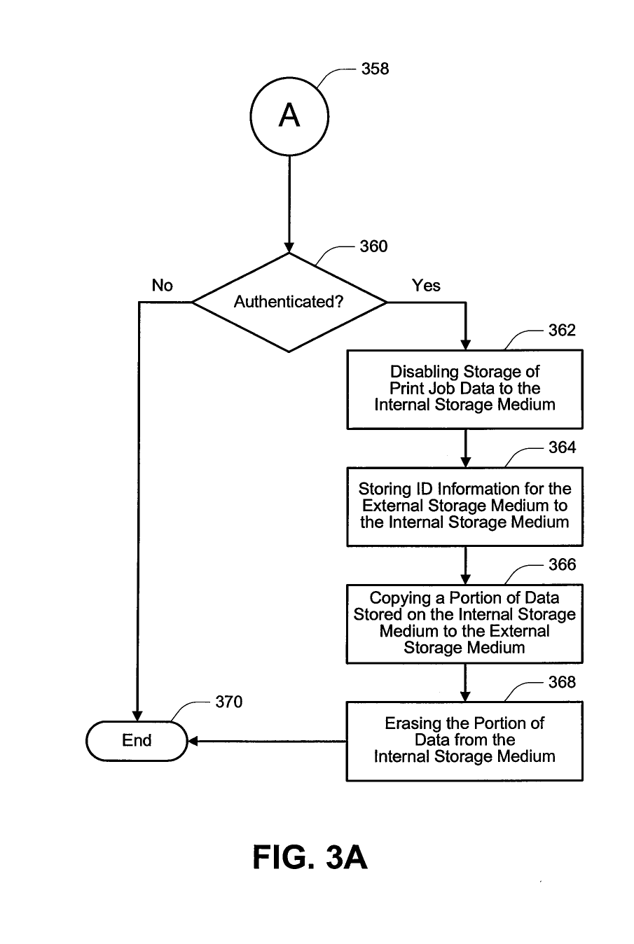

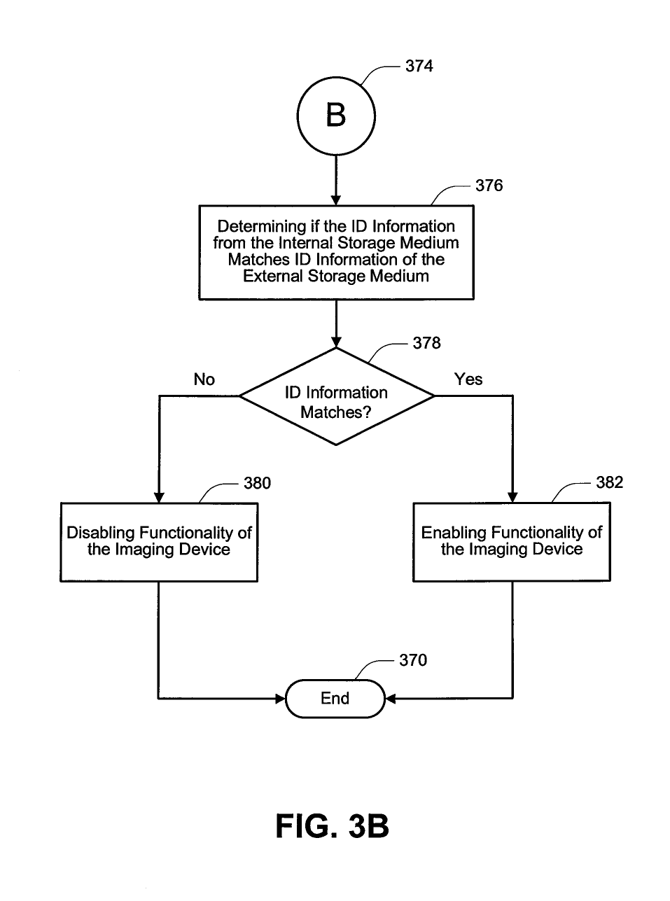

FIGS. 3, 3A and 3B are flowcharts of a method of operating an imaging device in accordance with another embodiment of the disclosure. With reference to FIG. 3, the method of this embodiment includes detecting an external storage medium coupled to the imaging device at 350. As noted with respect to FIG. 2, such detection can include periodic monitoring of the peripheral port. When an external storage device is detected at 350, the method continues by determining if identification (ID) information of an external storage medium is contained on an internal storage medium of the imaging device at 352. For example, such ID information may be stored in a particular file or a particular storage location of the internal storage medium such that the processor can determine whether such ID information is contained on the internal storage medium by reading the particular file or storage location. If ID information is not contained on the internal storage medium at 354, an authentication process is performed for the detected external storage medium at 356. The method then continues to 358 with reference to FIG. 3A.

If the detected external storage medium is not authenticated at 360, the method may end at 370. For some embodiments, if an external storage medium is coupled to the imaging device and not authenticated, a user may be prompted for input regarding the use or purpose of the unauthenticated external storage medium.

If the detected external storage medium is authenticated at 360, the method further includes disabling storage of print job data to the internal storage medium at 362. As noted above, storage of other user-specific data to the internal storage medium may also be disabled. At 364, ID information of the external storage device that was detected and authenticated is stored to the internal storage medium. This storage of ID information permits the imaging device to identify the external storage medium the next time it is connected to the imaging device, or the next time the imaging device is turned on, without performing an authentication process. The ID information may include information that is unique to the storage medium, such as information pertaining to a serial number of a particular manufacturer and model of the storage medium. The ID information may further include information that may be shared among a number of storage media, such as capacity, format, type or source of the storage medium. In accordance with various embodiments of the disclosure, the ID information of the external storage medium has a data structure that is recognized by imaging devices configured in accordance with one or more embodiments described herein to indicate whether the storage medium has a particular set of characteristics necessary for authentication, and thus to disable storage of at least print job data to the internal storage medium.

A portion of data stored on the internal storage medium is copied to the external storage medium at 366. While blocks 362, 364 and 366 are shown to be performed in serial fashion in the example embodiment of FIG. 3A, these activities may be performed concurrently. For enhanced security, after copying a portion of data from the internal storage medium to the external storage medium at 366, that portion of data is erased from the internal storage medium at 368. The portion of data may include one or more instances of user-specific data previously stored to the internal storage medium. For certain embodiments, the portion of data copied to the external storage medium does not include device-specific data. As before, the erasure of data from the internal storage medium may include a secure erase operation. After erasing that portion of data from the internal storage medium, the method may end at 370. At this point, any data that is disabled from storage to the internal storage medium will be written to the external storage medium if it is connected.

Returning to FIG. 3, if ID information is contained on the internal storage medium at 354, the ID information is read from the internal storage medium at 372. The method then continues to 374 with reference to FIG. 3B. It is determined if the ID information read from the internal storage medium matches ID information of the external storage medium at 376. If the ID information does not match at 378, at least some functionality of the imaging device is disabled at 380. For example, if the ID information does not match, printing of the imaging device may be disabled, e.g., by not accepting print job data, or not storing print job data to any location usable by the formatter. However, the imaging device may still be enabled for certain functionality, such as testing, maintenance or status functions. For certain embodiments, disabling of certain functionality if a different external storage device is connected to the imaging device can facilitate pairing a particular imaging device to a particular external storage medium. If the ID information does match at 378, functionality of the imaging device is enabled at 382, i.e., functionality is not disabled in response to the determination, such that the imaging device will accept print job data and produce tangible output therefrom.

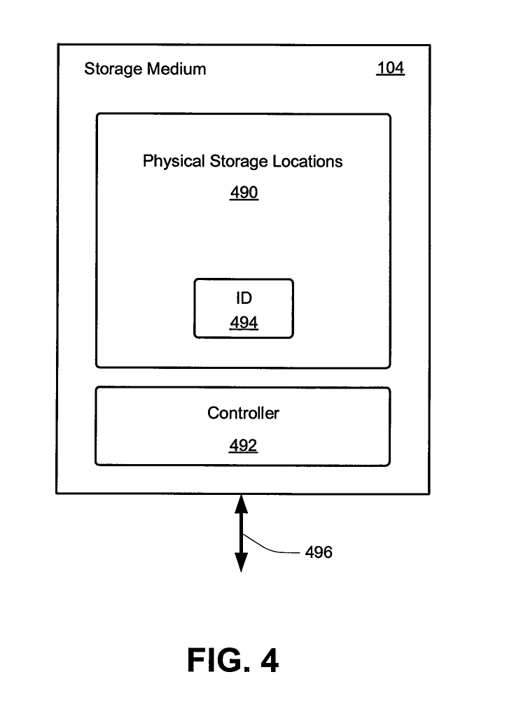

FIG. 4 is a block schematic of a storage medium 104 in accordance with an embodiment of the disclosure. The storage medium 104 includes a plurality of physical storage locations 490 and a controller 492. The physical storage locations 490 may include magnetic media, optical media, solid-state memory or other non-volatile, re-writeable computer-usable media. The controller 492 is configured to control access to the physical storage locations 490 in response to control signals and address signals received at I/O port 496, such as by processing read and write commands, and passing data to and from the physical storage locations 490 in response to the read and write commands, respectively.

Contained in a portion of the physical storage locations 490 is the ID information 494 associated with the storage medium 104. The ID information 494 has a data structure configured to cause a processor of an imaging device in accordance with one or more embodiments of the disclosure to disable storage of at least print job data to an internal storage medium when the I/O port 496 of the storage medium 104 is connected to a peripheral port of the imaging device. The ID information 494 may be encrypted. In addition, the file structure of the storage medium itself may be configured for data-at-rest encryption as described above.

Imaging devices and their use with particular external storage media have been described, and are useful in providing security to print job data and other user-specific data. In response to detecting an external storage medium coupled to the imaging device, the imaging device performs an authentication process, and disables storage of print job data to an internal storage medium of the imaging device in response to authenticating the external storage medium. In this manner, future print job data may be stored only on the external storage medium, allowing this data to be secured by removing and securing the external storage medium. The imaging device may further copy a portion of data stored on the internal storage medium to the external storage medium in response to authenticating the external storage medium, and to erase the portion of data from the internal storage medium after copying the portion of data to the external storage medium. In this manner, prior print job data and other user-specific data may be secured in the external storage medium. The imaging device may further store identification information for an authenticated external storage medium, and may enable full functionality of the imaging device only if the external storage medium matching the identification information is coupled to the imaging device. Security may be enhanced where an imaging device is paired with a single external storage medium, and permits printing only when coupled to that external storage medium.

Although specific embodiments have been illustrated and described herein, it is manifestly intended that the scope of the claimed subject matter not be limited to the specific embodiments.

What is claimed is:

1. A imaging device, comprising:
an internal storage medium;
a print engine; and
a processor coupled to the internal storage medium and the print engine;
wherein the processor is configured to detect coupling of an external storage medium to the imaging device;
wherein the processor is configured to perform an authentication process upon detecting the coupling of an external storage medium; and
wherein the processor is configured to disable storage of print job data to the internal storage medium in response to authenticating an external storage medium.

2. The imaging device of claim 1, wherein the processor is further configured to move a portion of data stored on the internal storage medium to the external storage medium in response to authenticating the external storage medium.

3. The imaging device of claim 1, wherein the processor is further configured to store identification information to the internal storage medium upon authenticating an external storage medium.

4. The imaging device of claim 3, wherein the processor is further configured to disable at least some functionality of the imaging device if an external storage medium matching the identification information is not coupled to the imaging device.

5. A method of operating a imaging device, comprising:
detecting coupling of an external storage medium to the imaging device;
performing an authentication process upon detecting the coupling of the external storage medium; and
disabling storage of print job data to an internal storage medium of the imaging device in response to authenticating an external storage medium.

6. The method of claim 5, further comprising moving a portion of data stored on the internal storage medium to the external storage medium in response to authenticating the external storage medium.

7. The method of claim 6, wherein moving the portion of data to the external storage medium comprises copying the portion of data to the external storage medium, and erasing the portion of data from the internal storage medium after copying the portion of data to the external storage medium.

8. The method of claim 6, wherein moving a portion of data to the external storage medium comprises moving user-specific data from the internal storage medium to the external storage medium.

9. The method of claim 8, wherein moving user-specific data from the internal storage medium comprises moving all user-specific data from the internal storage medium.

10. The method of claim 5, further comprising erasing a portion of the external storage medium in response to authenticating the external storage medium.

11. The method of claim 5, further comprising storing identification information for the external storage medium to the internal storage medium upon authenticating an external storage medium.

12. The method of claim 11, further comprising disabling at least some functionality of the imaging device if a different external storage medium is subsequently coupled to the imaging device.

13. The method of claim 12, wherein disabling at least some functionality of the imaging device comprises disabling printing by the imaging device.

14. The method of claim 5, wherein performing an authentication process comprises reading identification information from the external storage device, and determining whether a storage medium identified by the identification information satisfies a particular set of characteristics.

15. A method of operating a imaging device, comprising:
detecting an external storage medium coupled to the imaging device;
determining if identification information of an external storage medium is contained on an internal storage medium of the imaging device;
if identification information is contained on the internal storage medium:
reading the identification information from the internal storage medium;
determining if the identification information from the internal storage medium matches identification information of the external storage medium;
enabling functionality of the imaging device if a match is determined; and
disabling at least some functionality of the imaging device if a match is not determined; and
if identification information is not contained on the internal storage medium:
performing an authentication process on the external storage medium;
disabling storage of print job data to the internal storage medium in response to authenticating the external storage medium; and
storing identification information for the external storage medium to the internal storage medium in response to authenticating the external storage medium.

16. The method of claim 15, wherein disabling storage of print job data to the internal storage medium in response to authenticating the external storage medium comprises disabling storage of print job data and temporal data files associated with processing of print job data to the internal storage medium in response to authenticating the external storage medium.

17. The method of claim 15, further comprising moving at least a portion of data from the internal storage medium to the external storage medium in response to authenticating the external storage medium.

18. The method of claim 15, further comprising storing all data, for which storing to the internal storage medium is disabled, to the external storage medium.

19. A storage medium, comprising:
a plurality of physical storage locations; and
a controller configured to provide access to the plurality of physical storage locations;
wherein identification information is stored in a portion of the plurality of physical storage locations;
wherein the identification information has a data structure configured to cause a processor of an imaging device to disable storage of print job data to an internal storage medium of the imaging device in response to coupling the storage medium to the imaging device.

20. The storage medium of claim 19, wherein a file structure of the storage medium is configured for data-at-rest encryption.

21. The storage medium of claim 19, wherein the identification information includes information unique to the storage medium.
